(19) United States
(12) Patent Application Publication
(10) Pub. No.: US 2011/0057077 A1
(43) Pub. Date: Mar. 10, 2011

(54) Pool Skimmer Mount Umbrella Support System

(76) Inventor: Chris Johnson, Fresno, CA (US)

(21) Appl. No.: 12/871,903

(22) Filed: Aug. 30, 2010

Related U.S. Application Data
(60) Provisional application No. 61/238,122, filed on Aug. 28, 2009.

(51) Int. Cl. F16M 11/14; F16M 11/04

(52) U.S. Cl. 248/124.2; 248/121

(57) ABSTRACT

An umbrella support system for supporting an umbrella over the water surface of a pool. The system uses the pool's skimmer apparatus to support a pole above the deck and hang the umbrella at the end of the pole. The system includes a modified deck plate placed in the deck, a modified basket plate placed on the skimmer basket, a pole having a first end and a second end, an umbrella attachment mechanism hanging the umbrella from the first end of the pole and a basket plate engagement mechanism engaging the second end of the pole with the basket plate and/or basket. The second end of the pole passes through an aperture in the deck plate and engages the basket plate or the basket to extend the pole upward from the deck and over the water surface. The umbrella hangs downward from the pole to shade persons in the water.

### CROSS-REFERENCE TO RELATED APPLICATIONS

This patent application claims priority to U.S. Provisional Patent Application No. 61/238,122 filed Aug. 28, 2009.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to systems used for supporting an umbrella or like device by on a surface, such as a pool deck. In particular, the present invention relates to umbrella support systems that are used to support an umbrella over a surface so as to shade the surface from the sun. Even more particularly, this invention relates to such umbrella support systems that interact with a pool deck and are utilized to support an umbrella over the surface of a pool.

B. Background

Many people enjoy spending time in a pool or laying on a deck that is next to the pool. Typically, the time of year when people enjoy being in or by the pool is in the summer or the warmer days of the spring and fall, which is when the sun is warm enough to make the water enjoyable. Although the warm weather and heat of the sun draws people to a pool, including backyard pools, the heat of the sun is typically too much for the person to be exposed to the entire time that they are in or next to the pool. Besides being hot (sometimes very hot), direct exposure of the human skin to the rays of the sun can result in a sunburn, which can be very uncomfortable or even painful. In addition, most people are aware that long term exposure of human skin to the direct rays of the sun can damage the skin, resulting in premature age spots and/or dryness of the skin, and lead to skin cancer. Although the use of lotions and creams are known to provide a certain amount of protection to the skin, they are only beneficial if actually applied to the skin and to the extent they remain on the skin during swimming or other water activities. Generally, the lotions and creams do nothing to reduce the heat of the sun's rays, which in severe circumstances can cause heat stroke or other heat-related injury.

One common method of attempting to be cool on a hot summer day is to sit or lay under the shade provided by an umbrella. Most people who have backyard pools have at least a free standing umbrella or an umbrella that is part of a table/chair arrangement to provide shade next to a pool. Most free standing umbrellas have a stand comprising a portion that receives the umbrella's support pole and a weighted portion, which may be filled with sand, water, concrete or other material, that rests on the pool deck or other surface next to the pool. The portion that receives the support pole is typically configured as either a small upwardly disposed tube (e.g., a pipe) having a screw member that anchors the bottom of the support pole or an aperture in which the bottom of the support pole is inserted and then anchored to the weighted portion.

Although an umbrella placed poolside is useful for providing shade to those who are sitting or laying down next to the pool, such as directly on the pool deck, in a chaise lounge or on a chair positioned around a table on the deck, they are not that useful for providing shade to persons in the pool. While a person who is swimming in a pool typically does not need to have shade because they are immersed in and moving through the water, people generally do not spend most of their time in the pool swimming. As well known to pool owners, those who go to a pool and pool manufacturers, most people at a pool tend to either sit on a pool step or other structure in the pool, stand or sit on the bottom of the pool (in the shallow end) or float on a mat or other device. Although being in the water of a pool can keep part of the person cool and prevent damage or harm from the sun, the part of the person out of the water is exposed to the sun's rays and can get sunburned or otherwise harmed. In addition to harm, being exposed to the sun can be uncomfortably hot.

Some pools have trees or structures which provide some shade to persons who are in the pool for at least part of the day, depending on the angle of the sun and the position of the tree or structure. Unfortunately, the person using the pool cannot beneficially adjust the location of the shade by moving the tree or structure to a position where the sun is blocked and the resulting shade is over the pool where the person is in the water. With regard to the use of umbrellas, a person can use a freestanding umbrella next to the pool in an attempt to provide shade for a person in the water. Typically, however, the adjustments available to the umbrella support pole or the umbrella itself are not sufficient to provide shade over the water surface at all times of the day, particularly when the sun is directly overhead, such as the hours around noon or so, which is when the shade is most needed. In addition, even though some of the freestanding umbrella stands can be moved to different places next to the pool, most of them are not configured to be easily moved and, due in part to the weighted portion and length of the support pole, are in fact somewhat difficult to move.

What is needed is an improved umbrella support system that is particularly useful for supporting an umbrella over the water surface of a pool in a manner that provides shade over the water so as to protect and comfort a person in the pool from the sun's rays. The preferred umbrella support system should be configured to position an umbrella over the pool in a manner that blocks the sun's rays to shade a portion of the water surface so a person can stand, sit or float in or on the water with significantly less risk of sunburn or other damage to their skin or being uncomfortable due to the heat of the sun's rays. The umbrella support system should be configured for use by most backyard or even commercial pools by utilizing an existing in-ground component of the pool. The preferred umbrella support system should be easy to set up and easy to use.

### SUMMARY OF THE INVENTION

The umbrella support system of the present invention provides the benefits and solves the problems identified above. That is to say, the present invention discloses an umbrella support system that easily and directly provides shade over a portion of the pool so as to shade a person who is standing, sitting or floating in or on the water. The preferred umbrella support system attaches to a portion of a pool's existing filter system, without reducing its performance, to receive a support pole having an umbrella which provides shade to at least a portion of the water in the pool. Preferably, the umbrella support system also includes an attachment apparatus that holds beverage containers and/or supports food, drinks and other items below the umbrella and above the water for easy access and use by persons who are in the pool.

The umbrella support system is utilized to support an umbrella generally over the water surface of a pool. In a primary embodiment of the present invention, the umbrella support system comprises a skimmer basket configured to be received in a deck associated with the pool, a modified basket plate integral with or attached to the top of the skimmer basket, a support pole having a first end and a second end, a modified deck plate configured to be placed in a surface of the deck above the basket plate, an umbrella attachment mechanism at or near the first end of the support pole for attaching the umbrella to the first end of the support pole and a basket plate engagement mechanism at or near the second end of the support pole for engaging the support pole with at least one of the basket plate and the skimmer basket so as to support the support pole above the deck with the umbrella over the water surface. The deck plate has a deck plate body and a deck plate aperture through the deck plate body, with the deck plate aperture being sized and configured to allow the support pole to pass therethrough to the basket plate where it engages the basket plate and/or the basket. The support pole extends upward from the deck and outward to position the first end of the support pole, and therefore the umbrella, over the surface of the water where the umbrella will provide shade for persons in the pool. An attachment apparatus is configured to attach to and hang below the umbrella to support beverage containers, drinks, food and other items above the water surface for access to persons in the pool. In a preferred embodiment, the attachment apparatus is supported below the umbrella by an attachment pole that is connected to an attachment connector at the umbrella.

Accordingly, the primary aspect of the present invention is to provide an umbrella support system that provides the benefits described above and solves the problems presently associated with presently available umbrella support systems.

It is a primary aspect of the present invention to provide an umbrella support system that easily and directly shades a portion of the water in a pool by supporting the umbrella in a generally hanging position over the water surface.

It is also an important aspect of the present invention to provide an umbrella support system that utilizes an existing component of the pool filtering system to support an umbrella over the surface of the pool water so it shades a portion of the water.

It is also an important aspect of the present invention to provide an umbrella support system that supports an umbrella over the surface of the water by utilizing the deck of the pool and the pool's skimmer basket to support a pole that positions the umbrella over the pool surface.

It is also an important aspect of the present invention to provide an umbrella support system generally having an umbrella, a support pole sized and configured to extend the umbrella over the water surface of a pool, an umbrella attachment mechanism to attach the umbrella to the first end of the support pole and pool skimmer mounting mechanism to support the second end of the support pole at the deck around the pool.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of an umbrella support system configured according to a preferred embodiment of the present invention shown with the support pole mounted in the deck and the umbrella disposed over the water surface of a pool;

FIG. 2 is an exploded side view of the umbrella support system of FIG. 1;

FIG. 3 is an alternative embodiment of the umbrella support system of FIG. 1 showing use of telescoping pole members with the umbrella disposed over the water surface of a pool;

FIG. 4 is an exploded side view of the umbrella attachment mechanism utilized with the umbrella support system of FIG. 1;

FIG. 5 is a bottom view of the deck plate utilized with the umbrella support system of FIG. 1;

FIG. 6 is an exploded side view of the basket plate engagement mechanism utilized with the umbrella support system of FIG. 1;

FIG. 7 is a top plan view of the basket plate utilized with the basket plate engagement mechanism of FIG. 6;

FIG. 8 is a perspective view of an alternative basket plate engagement mechanism for use with the umbrella support system of the present invention;

FIG. 9 is a top plan view of the basket plate utilized with the basket plate engagement mechanism of FIG. 8;

FIG. 10 is an exploded side view of an alternative basket plate engagement mechanism for use with the umbrella support system of the present invention;

FIG. 11 is a top plan view of the basket plate utilized with the basket plate engagement mechanism of FIG. 10;

FIG. 12 is a side view of an alternative configuration for the umbrella support system of the present invention shown with the basket plate engagement mechanism of FIG. 10 and utilizing an alternative umbrella attachment mechanism;

FIG. 13 is a side view of a beverage holder attachment apparatus shown in use with the umbrella support system of FIG. 1;

FIG. 14 is a side view of a table attachment apparatus shown in use with the umbrella support system of FIG. 1; and

FIG. 15 is a side view of a combination beverage holder and table attachment apparatuses shown in use with the umbrella support system of FIG. 1.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain shapes and configurations for the various components of an umbrella support system, those skilled in the art will understand that this is merely for purposes of simplifying this disclosure and that the present invention is not so limited.

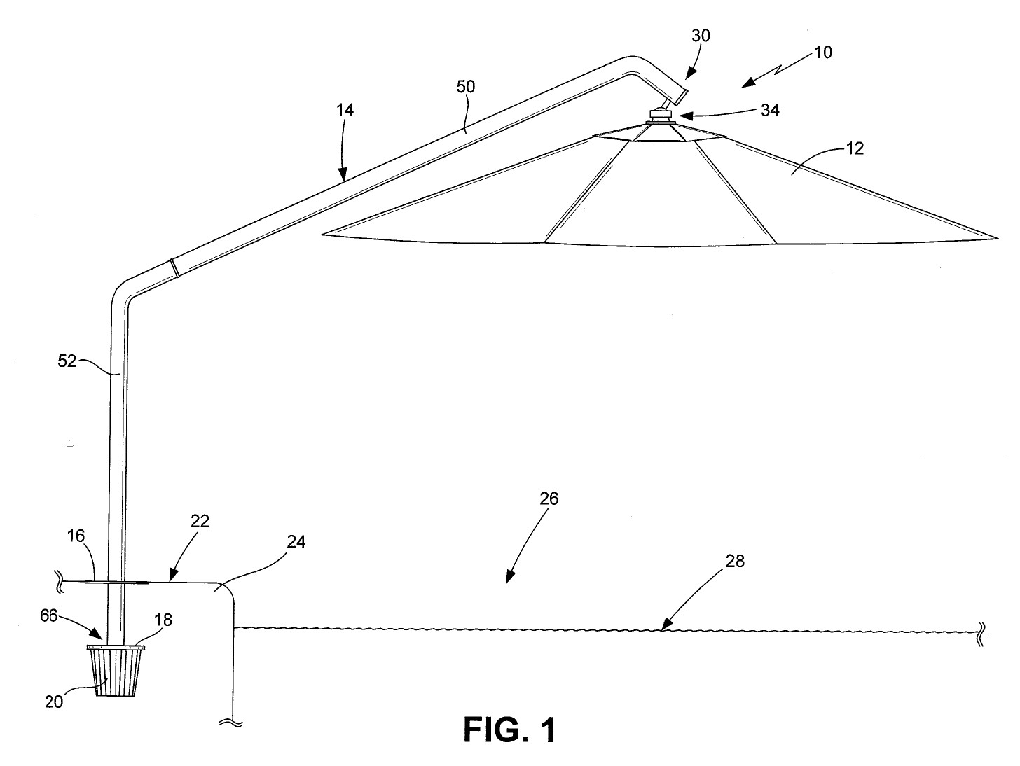

An umbrella support system that is manufactured out of the materials and configured pursuant to a preferred embodiment of the present invention is shown generally as 10 in FIGS. 1 through 3. The umbrella support system 10 generally comprises an umbrella 12, support pole 14, deck plate 16, basket plate 18 and pool filter/skimmer basket 20. As will be explained in more detail below, the umbrella support system 10 is configured to support the pole 14 above the surface 22 of deck 24 around a pool 26 in a manner that positions the umbrella 12 substantially over the water surface 28 of the pool 26, as shown in FIGS. 1, 3 and 12. Typically, the umbrella support system 10 of the present invention will utilize the existing skimmer basket 20 of pool 26 that is part of the pool's filter system. Alternatively, the user can be provided with a new skimmer basket 20 that is integral with or removably attached to basket plate 18 to use with his or her pool filtration system. Umbrella 12 can be any type of umbrella that is configured to be supported by a standard support pole with the modifications described below (as may be necessary) to hang or otherwise be disposed below the outwardly extending first end 30 of support pole 14. As explained in more detail below, the second end 32 of support pole 14 will be supportedly engaged with basket plate 18 and/or basket 20. Although a standard, vertical umbrella pole can be utilized with the present invention, it is preferred that support pole 14 be configured to dispose the umbrella 12 over the water surface 28 of pool 26, as shown in FIG. 1. A standard umbrella pole, which is generally configured to be substantially straight, will only result in the umbrella 12 being straight above the deck plate 16 instead of over the water surface 28 of pool 26, as is desired for the preferred use of the present invention.

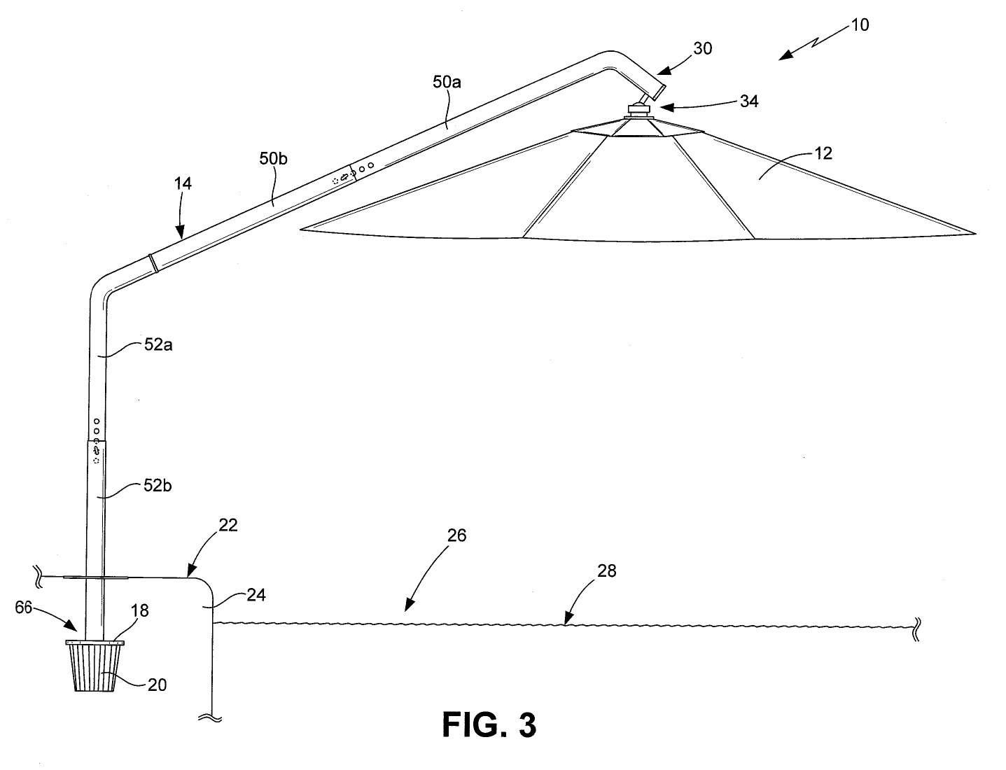

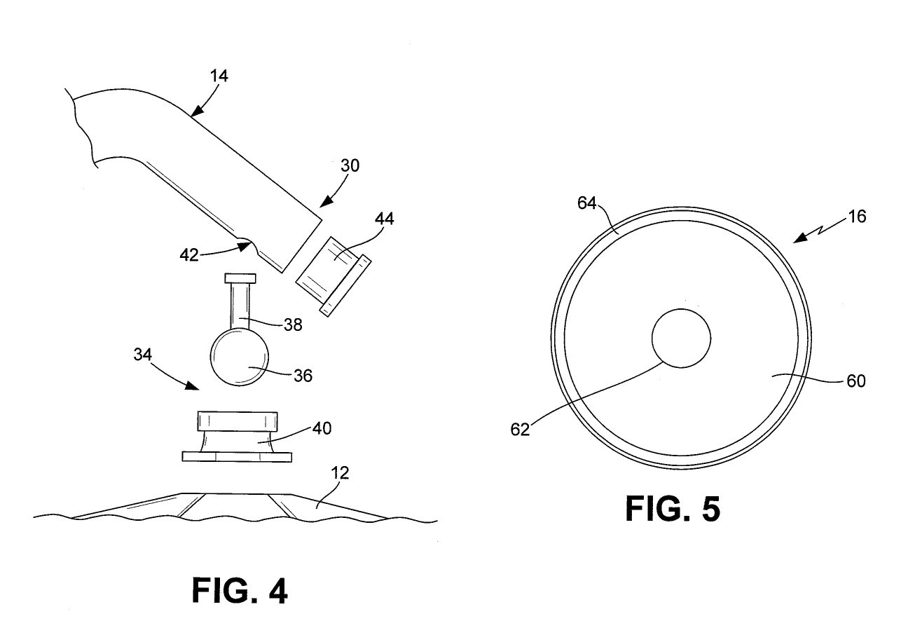

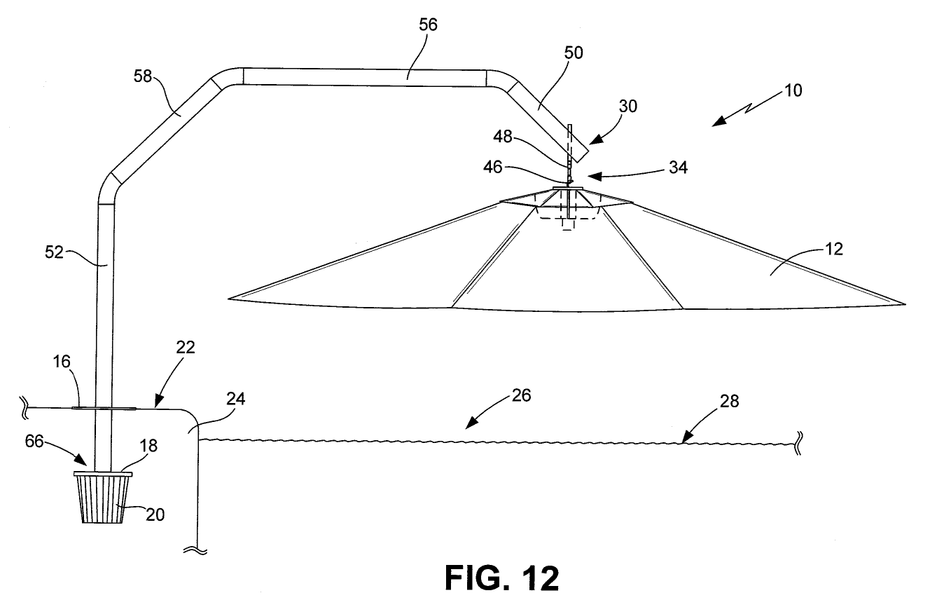

The umbrella 12 is attached at or near the first end 30 of support pole 14 utilizing an umbrella attachment mechanism 34 configured to support the umbrella 12 with the top or apex of the umbrella 12 directed upward so that it may spread out over the water surface 28, as shown in FIGS. 1 and 3, where the user desires shade. In a preferred embodiment, the umbrella attachment mechanism 34 is configured for the umbrella 12 to removably attach to the support pole 14. Various attachment mechanisms, which are generally well known in the art, can be utilized to connect the umbrella 12 to the first end 26 of support pole 14 such that umbrella 12 hangs over water surface 28. Preferably, umbrella attachment mechanism 34 connects the umbrella 12 to the first end 26 of support pole 14 in a manner that allows some movement of umbrella 12 in response to blowing wind. If desired, however, a relatively stiff or a rigid member, such as a rod, pole, tube or the like, can be utilized instead of a pivoting or flexible umbrella attachment mechanism 34 to reduce or even eliminate any swaying of umbrella 12. In the embodiment shown in FIGS. 1 through 4, the umbrella attachment mechanism 34 comprises a ball and seat apparatus having a ball 36 attached to a rod 38 that is supported by the first end 30 of support pole 14 and a seat device 40 connected to the umbrella 12 that pivotally receives the ball 36 therein, as best shown in FIG. 4, to allow the umbrella 12 to pivot or sway below the first end 30 of support pole 14, as shown in FIGS. 1 and 3. Rod 38 is received through pole aperture 42 at or near the first end 30 of support pole 14. In a preferred embodiment, an end cap 44 is placed at the open first end 30 of support pole 14. In an alternative embodiment, the umbrella 12 is provided with a connecting member 46, such as a hook, at the top or apex of umbrella 12, that is configured to removably connect to a hanging support member 48, such as the chain shown in FIG. 12, in a manner that allows umbrella 12 to hang over the portion of the water surface 28 where the user desires shade while using pool 26. As will be readily appreciated by those skilled in the art, many different types of connecting members 46 can be utilized instead of the hook, such as clips and the like, and many different types of support members 48 can be utilized instead of the chain, including rope, wire, cable or the like. Alternatively, support member 48 can be a stiff member such as a tube, pipe, rod or the like.

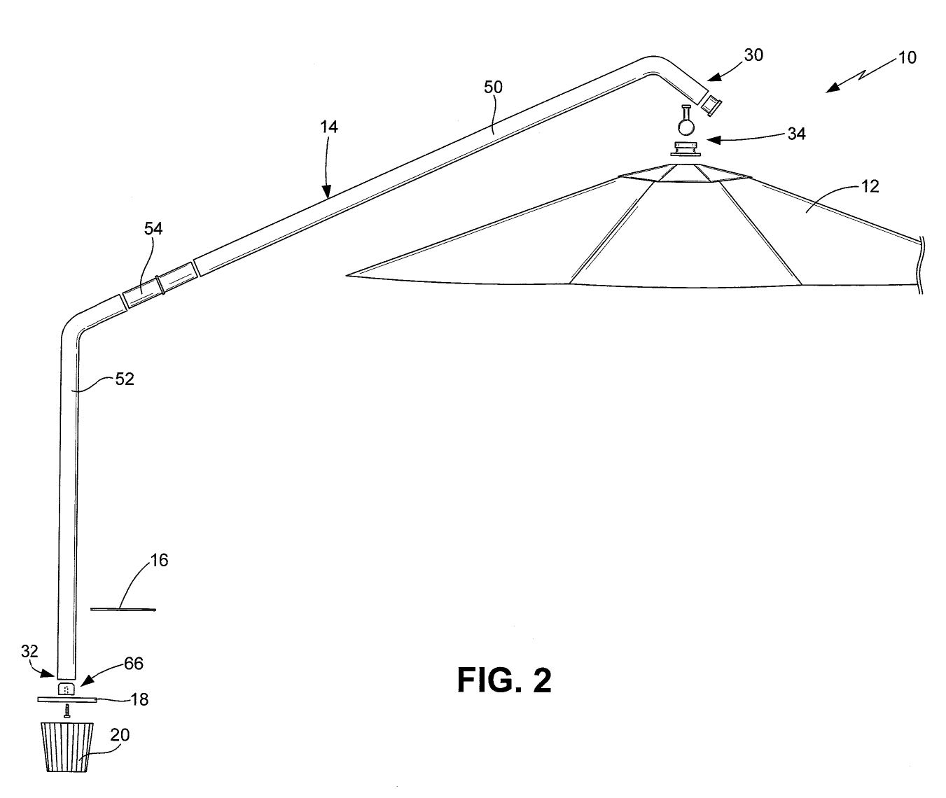

Support pole 14 for use with the umbrella support system 10 of the present invention should be configured to dispose umbrella 12 over the portion of the pool 26 the user desires to shade. As best shown in FIGS. 1 through 3 and 12, the support pole 14 is generally configured in an upside down J configuration, with the long end of the “J” (i.e., the second end 32) being engaged with basket 20, as described below and the short end of the “J” having umbrella attachment mechanism 34 to interconnect the umbrella 12 and support pole 14. In the preferred configuration, support pole 14 comprises a plurality of interconnecting or interlocking tubular members, such as first pole member 50 and second pole member 52 in FIGS. 1 through 3, that are connected together to form the desired length and shape. In a preferred embodiment, a tube connector 54 is utilized to connect the adjacent ends of the first 50 and second 52 pole members, as best shown in FIG. 2. Alternatively, the adjacent ends of the pole members 50/52 can be sized and configured for interlocking engagement. In the embodiment of FIG. 12, support pole 14 also comprises a third pole member 56 and a fourth pole member 58. Although support pole 14 may be provided as a single piece pole of the desired length, a multiple piece support pole 14 has the benefit of allowing the user to disconnect pole members 50/52 or 50-54 when the umbrella support system 10 is not needed (e.g., during winter when the pool is not being utilized) for ease of handling and storage. In addition, a modular pole configuration reduces the cost of shipping and storing umbrella support system 10 for the manufacturer and retailer. In one embodiment, support pole 14 is configured to allow the user to select the desired lengths of one or more of pole members 50/52. As shown in FIG. 3, each pole member 50/52 can comprise two separate members 50a/50b and 52a/52b that are telescopically or otherwise configured to extend or retract in length as may be desired by the user depending on the size of pool, target area for the shade, overhang height of surrounding structures or vegetation and/or other factors. In the embodiment shown in FIG. 3, the various pole submembers 50a/50b and 52a/52b connect using a retractable pin and multi-aperture arrangement. As well known in the art, other types of extension systems may also be applicable to the support poles 14 utilized with the umbrella support system 10. The support pole 14 can be made out of a variety of different materials, including plastic, composites or metal. The material should be corrosion resistant and, preferably for ease of handling, of reasonable weight. In one embodiment, the support pole 14 is made out of aluminum which is powder coated for improved performance.

Deck plate 16 and basket plate 18, best shown in FIGS. 4 through 6, will replace the existing or standard deck plate and basket plate which are utilized with the pool's filtering system. As well known, the pool filtering system includes an intake that draws water from the pool 26 toward a system of filters that filters, and in some cases heats, the water and then pumps it back in to the pool 26. The typical intake includes a removable skimmer basket 20 that prefilters the water to remove the larger debris so as to prevent excessive clogging of the filters and damage to the pumps that push or pull the pool water through the filters. Skimmer basket 20 resides at the bottom of a chamber that is covered by the standard deck plate, which is primarily solid so that people can walk over it without falling into the chamber. A standard basket plate is configured to enclose skimmer basket 20 in a manner that still allows water and debris to be drawn into skimmer basket 20. Periodically, the pool operator or owner removes the basket 20 from the chamber to dispose of the larger debris.

The deck plate 16 of the present invention includes a solid deck plate body 60 with a deck plate aperture 62, which will typically be positioned at or near the center of deck plate 16 as best shown in FIG. 5, that is sized and configured to receive the support pole 14, or at least the relevant pole member (i.e., member 52) therethrough. In a typical configuration, support pole 14 will have a round cross-section, requiring a circular configuration for deck plate aperture 62 that is only slightly larger than the outside diameter of the second end 32 of support pole 14. Preferably, the outer peripheral edge 64 of the deck plate 16 is beveled to allow a portion of the deck plate 16 to sit inside of the chamber where skimmer basket 20 is positioned such that the upwardly disposed top surface of deck plate 16 is substantially planar with the surrounding deck surface 22, as shown in FIGS. 1, 3 and 12. As with the standard deck plate, the deck plate body 60 of deck plate 16 should be configured to allow people to walk across the deck plate 16 when walking on the deck 24 and the support pole 14 of umbrella support system 10 is not in place. As with standard deck plates, various plastic and composite materials are generally suitable for deck plate 16.

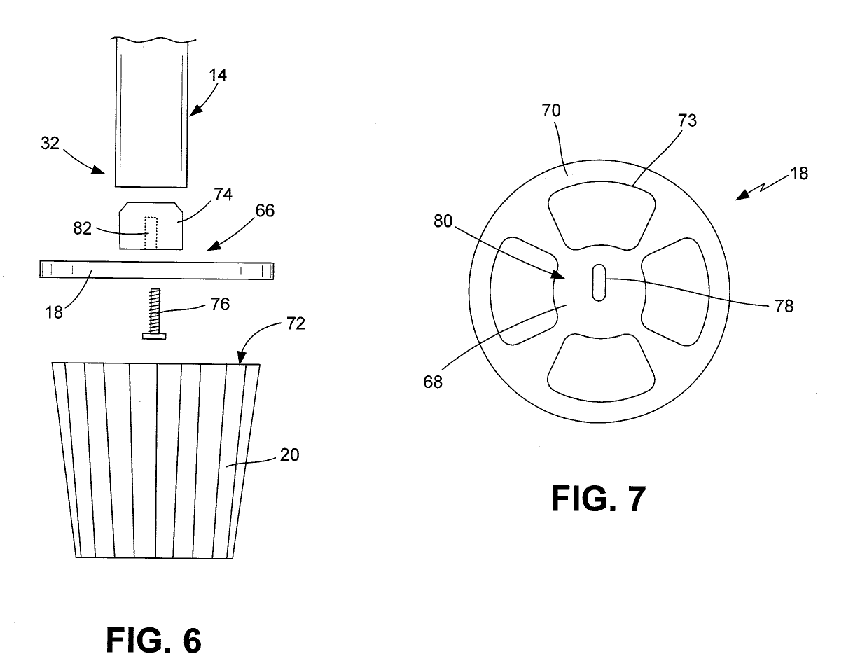

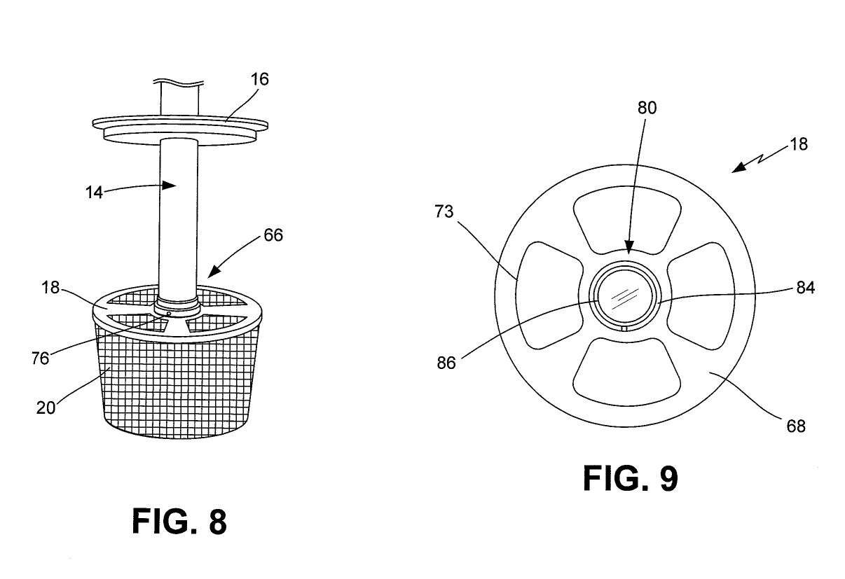

The umbrella support system 10 of the present invention utilizes a basket plate engagement mechanism 66 at or near the second end 32 of support pole 14 for engaging the support pole 14 with the basket plate 16 and/or the skimmer basket 20, as shown in FIGS. 1, 3, 6, 8, 10 and 12-15. Basket plate 18 is sized and configured to securely attach to the top of basket 20, as best shown in FIG. 8. Basket plate 18 will comprise a solid basket plate body 68 that is sufficiently strong enough to support the second end 32 of support pole 14 in a generally vertical configuration, as shown in FIGS. 1 through 3 and 12. The outer or peripheral edge 70 of the basket plate body 68 is sized and configured to engage and be supported by the upper peripheral edge 72 of the basket 20, as shown in FIGS. 6 and 7. Preferably, the basket plate 18 is removably attached to basket 20, as is generally typical for existing lids or other covers for skimmer baskets 20, so the user may remove it as necessary to remove the leaves and other trash material, which are received in basket 20 through the relatively large trash apertures 73 in basket plate 18, that are trapped in the basket 20 as part of the pool's filtration system.

A variety of different basket plate engagement mechanisms 66 can be utilized with the umbrella support system 10 of the present invention. In FIGS. 1 through 3, 6 and 7, the basket plate engagement mechanism 66 comprises a tube insert member 74 that is sized and configured to be received in the open second end 32 of support pole 14, as best shown in FIG. 6, a connector 76 that connects to the tube insert member 74 and secures it to the basket plate 18 and a basket plate aperture 78 sized and configured to allow a portion of connector 76 to pass through the basket plate 18 so that it may connectedly engage the tube insert member 74 and secure it to the top surface 80 of basket plate 18. In the embodiment shown in FIGS. 6 and 7, the connector 76 is a bolt, the tube insert member 74 has a cooperatively threaded aperture 82 that is sized and configured to receive the connector/bolt 76 and the basket plate aperture 78 is generally configured as a slot. When connector 74 is threadably inserted into the aperture 82 and tightened, tube insert member 74 is clamped to the top surface 80 of basket plate 18. In use, the second end 32 of support pole 14 is positioned over the tube insert member 74 and then pushed down to engage the tube insert member 74 inside its open second end 32. With the support pole 14 through the deck plate aperture 62 of deck plate 16 and the deck plate 16 in position in deck 24, the tube insert member 74 sufficiently supports the second end 32 of support pole 14 as the first end 30 thereof extends outwardly over the water surface 28 of pool 26 with the umbrella 12 hanging from the first end 30 of support pole 14, as shown in FIGS. 1 and 3.

An alternative basket plate engagement mechanism 66 is shown in FIGS. 8 and 9. In this embodiment, a bracket 84 is fixedly attached to the top surface 80 of basket plate 18. The bracket 84 defines an upwardly disposed pole receiving section 86 that is sized and configured to receive the second end 32 of support pole 14 therein and connect thereto using a connector 76, such as a bolt, screw or the like. Alternatively, a pin or pin-like device can be inserted through the bracket 84 to engage the second end 32 of support pole 14. When engaged with the second end 32 of support pole 14, the bracket 84 connects the support pole 14 to the basket plate 18. With deck plate 16 positioned in deck 24, the bracket 84 secures the second end 32 of support pole 14 so the first end 30 thereof may extend outward over the water surface 28 of pool 26 while supporting the umbrella 12 therefrom.

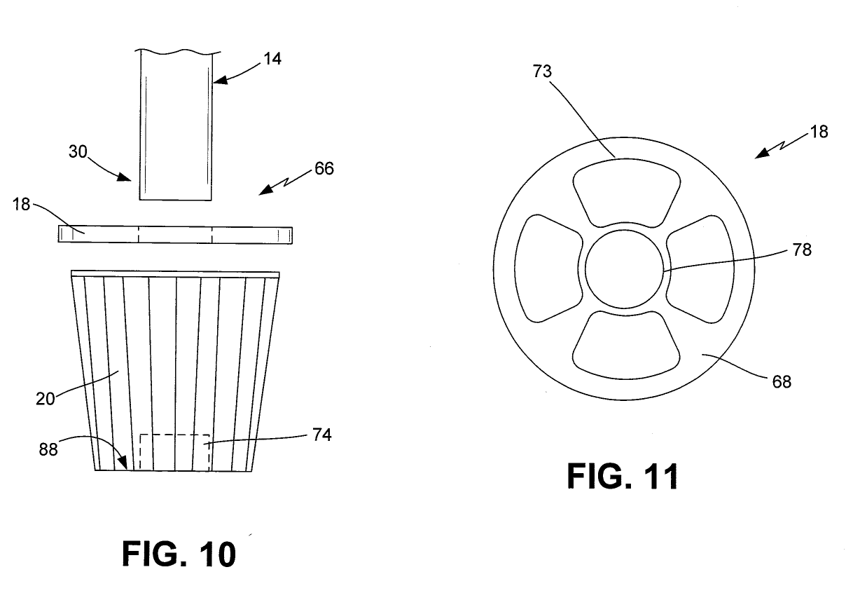

Another alternative embodiment for the basket plate engagement mechanism 66 is shown in FIGS. 10 through 12. In this embodiment, the basket plate aperture 78 in basket plate 18 is positioned at or near the center of the basket plate 18 and is sized and configured to receive the second end 32 of the support pole 14 therethrough. Preferably, basket plate aperture 78 is sized so as to be only slightly larger than the size (i.e., diameter) of the second end 32 of support pole 14 to support the support pole 14 in cooperation with the deck plate 16 positioned in deck 24. In one configuration for this embodiment, a tube insert member 74, sized and configured to be received inside the open second end 32 of support pole 14, is positioned at the bottom wall 88 inside basket 20 to engage the second end 32 of support pole 14 to better support the support pole 14 when the first end 30 thereof extends outwardly over the water surface 28 of pool 26 with the umbrella 12 hanging therefrom, as shown in FIG. 12. If desired, a pin or other device can be utilized to securely connect the second end 32 of support pole 14 with the tube insert member 74 inside basket 20. As with the previous embodiments, trash apertures 73 are configured to allow pool water and the debris associated therewith to flow through basket plate 18 into basket 20.

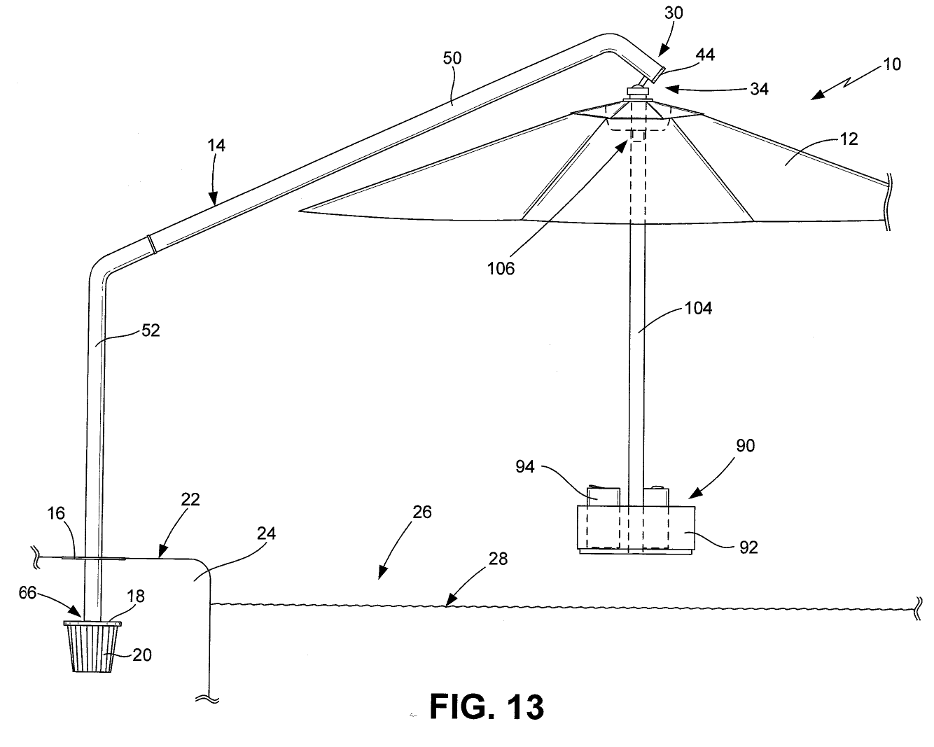

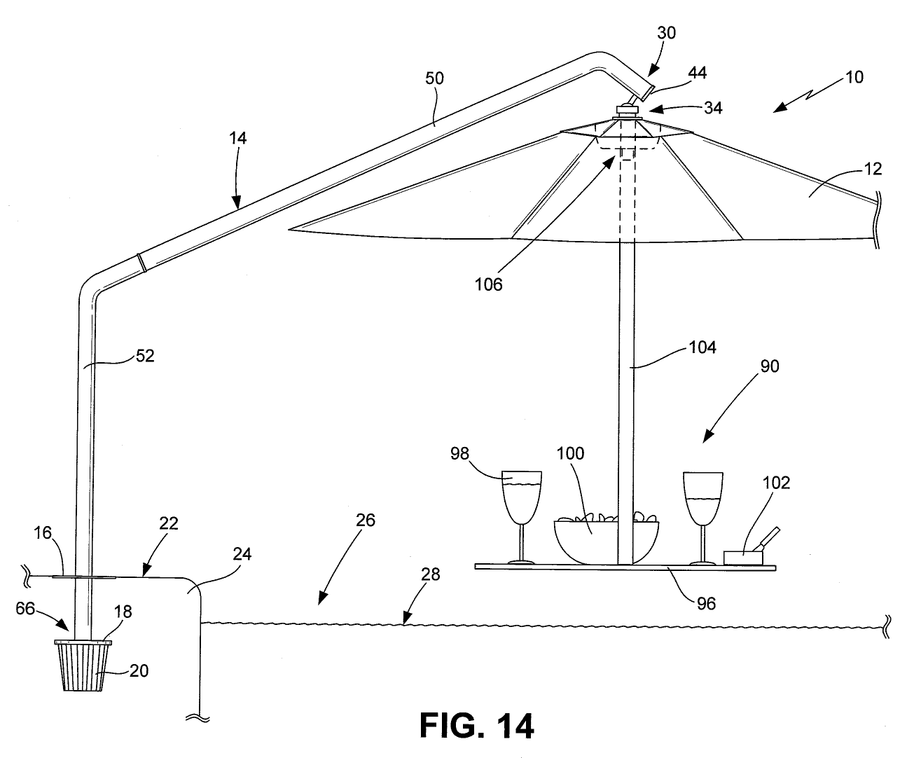

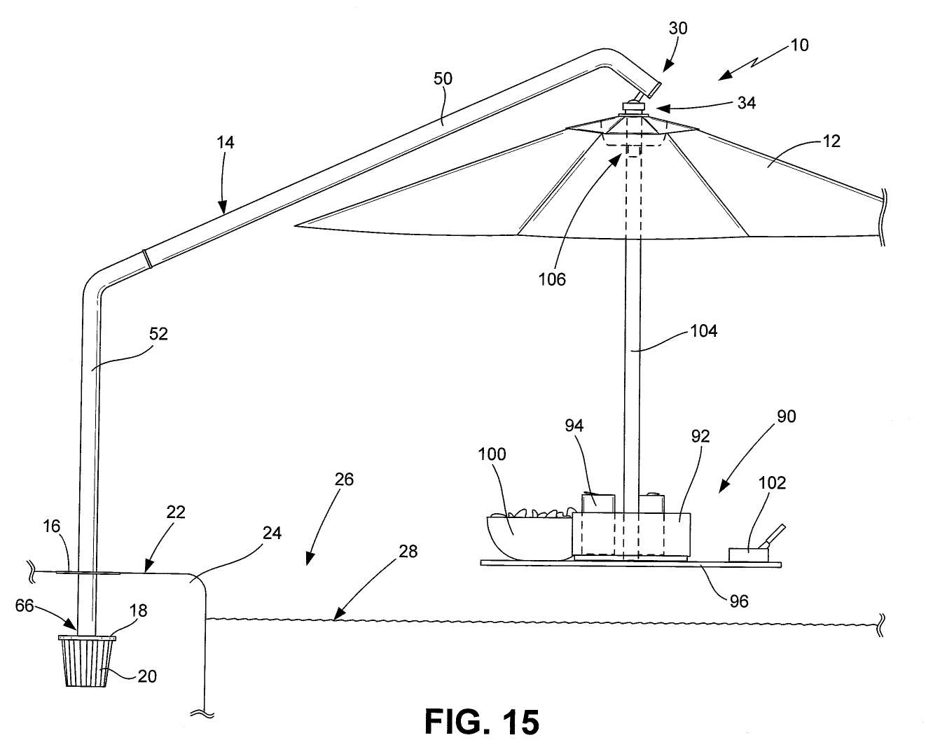

The preferred configuration of the umbrella support system 10 of the present invention also includes an attachment apparatus 90, shown on FIGS. 13 through 15, that can further increase the use and enjoyment of umbrella support system 10. As shown in FIGS. 13-15, the attachment apparatus 90 is configured to be supported below umbrella 12 and, in the preferred configuration, above the water surface 28. In one embodiment, shown in FIG. 13, attachment apparatus 90 comprises a beverage holder 92 configured to hold a plurality of cans, bottles or other beverage containers 94. Preferably, the beverage holder 92 is also configured to hold ice or other material or otherwise is configured to keep the drinks in containers 94 cold for improved enjoyment of the user. In a preferred embodiment, the beverage holder 92 has a removable, securable lid or other closing device that allows the user to open the beverage holder 92 and place ice or other cold materials inside. In an alternative embodiment, shown in FIG. 14, the attachment apparatus 90 is a refreshment table 96 that provides a flat surface on which the user can place drinks (including drinks in glass 98), food (such as the chips 100) and other snack-related items (such as dip 102). In the alternative embodiment shown in FIG. 15, the attachment apparatus 90 is a combination beverage holder 92 and refreshment table 96 that can be utilized to hold a plurality of beverage containers 94 and food and food related items 100/102. In a preferred embodiment, the attachment apparatus 90 is attached to an attachment support 104 that supports the attachment apparatus 90 below the umbrella 12, as shown in FIGS. 13-15. Preferably, the attachment support 104 is a tube, pole, rod or like member that is stiff so as to limit movement of the attachment apparatus 90 relative to the umbrella 12. A attachment connector 106 is utilized to interconnect the attachment apparatus 90 with the umbrella 12. Attachment connector 106 can be a threaded male end that threadably engages a threaded female end, a removable pin/aperture combination, a retractable pin/aperture device, a twist and lock mechanism or a variety of other devices that are utilized to connect, preferable removably connect, a tubular member to another structure (i.e., the attachment support 104 to the umbrella 12). One advantage of the attachment apparatus 90 shown in FIGS. 13-15 is that it will not float away from the user, as is typical of many of the pool refreshment holders currently available. Various configurations of beverage holder 92 and refreshment plate 96 are generally well known to those skilled in the art.

In use, the user will replace his or her existing deck plate and basket plate with the specially configured deck plate 16 and basket plate 18 described above. In one embodiment, basket plate 18 will be attached to the user's existing basket 20. In another embodiment, the user will be supplied with a combination basket plate 18 and basket 20 configured for use with the umbrella support system 10 of the present invention. Depending on the configuration utilized for the basket plate engagement mechanism 66 and whether supplied as a single component with basket plate 18, the user will either put the components together or, if already constructed, merely place the basket plate 18 and basket 20 inside the skimmer chamber and then place the deck plate 16 at the top of the chamber, preferably at least generally planar with the surrounding deck. In a preferred embodiment, support pole 14 is formed from two or more pole members, such as pole members 50 and 52. Utilizing an umbrella attachment mechanism 34, such as those described above, the user connects the umbrella 12 to the support pole 14 at or near the first end 30 thereof. Utilizing the basket plate engagement mechanism 66, the second end 32 of support pole 14 is engaged with the basket plate 18 and/or basket 20 to generally support the support pole 14 upward from the deck 24 with the first end 30 of support pole 14 positioned outwardly such that the umbrella 12 is disposed over the surface water 28 of pool 26. Once in place, umbrella 12 will provide shade to persons in pool 26 to prevent sunburns or other sun/heat related problems. If desired, prior to positioning the umbrella 12 over the water surface 28 the user can connect one of the attachment apparatuses 90 described above to the umbrella 12, utilizing attachment pole 104 and attachment connector 106 (or like devices), so that he or she can have cold beverages, food and/or other items easily available while to them while relaxing in pool 26 under the shade provided by the umbrella support system 10 of the present invention.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. An umbrella support system for supporting an umbrella generally over a water surface of a pool, comprising:
a skimmer basket configured to be received in a deck associated with the pool;
a basket plate integral with or attached to said skimmer basket;
a support pole having a first end and a second end;
a deck plate configured to be placed in a surface of the deck above said basket plate, said deck plate having a deck plate body and a deck plate aperture through said deck plate body, said deck plate aperture sized and configured to allow said support pole to pass therethrough;
an umbrella attachment means at or near said first end of said support pole for attaching said umbrella to said first end of said support pole; and
a basket plate engagement means at or near said second end of said support pole for engaging said support pole with at least one of said basket plate and said skimmer basket so as to support said support pole above the deck with said umbrella over the water surface.

2. The umbrella support system of claim 1, wherein said support pole comprises two or more pole members.

3. The umbrella support system of claim 1, wherein said umbrella attachment means is configured to allow said umbrella to hang from said support pole.

4. The umbrella support system of claim 3, wherein said umbrella attachment means comprises a ball and a seat device configured to retain at least a portion of said ball.

5. The umbrella support system of claim 3, wherein said umbrella attachment means comprises a connecting member attached to said umbrella and a support member interconnecting said connecting member and said support pole.

6. The umbrella support system of claim 1, wherein said deck plate is substantially planar with the surface of the deck.

7. The umbrella support system of claim 1, wherein said basket plate engagement means comprises a tube insert member and a connector received through a basket plate aperture in said basket plate to attach said tube insert member to a top surface of said basket plate, said tube insert member sized and configured to be received in said second end of said support pole so as to engage said second end of said support pole with said basket plate.

8. The umbrella support system of claim 1, wherein basket plate engagement means comprises a bracket on said top surface of said basket plate, said bracket having an upwardly disposed pole receiving section sized and configured to receive said second end of said support pole and a connector, said connector configured to connect said second end of said support pole to said bracket so as to engage said second end of said support pole with said basket plate.

9. The umbrella support system of claim 1, wherein basket plate engagement means comprises a basket plate aperture in said basket plate, said basket plate aperture sized and configured to allow said second end of said support pole to pass therethrough.

10. The umbrella support system of claim 9 further comprising a tube insert member at a bottom wall of said basket, said tube insert member sized and configured to be received in said second end of said support pole.

11. The umbrella support system of claim 1 further comprising an attachment apparatus configured attach to and hang below said umbrella.

12. The umbrella support system of claim 11, wherein said attachment apparatus is supported below said umbrella by an attachment pole, said attachment pole connected to an attachment connector at said umbrella.

13. An umbrella support system for use in combination with a pool having a deck to support an umbrella generally over a water surface of the pool, said umbrella support system comprising:
a skimmer basket received in the deck;
a basket plate integral with or attached to said skimmer basket;
a support pole having a first end and a second end;
a deck plate in a surface of the deck above said basket plate, said deck plate having a deck plate body and a deck plate aperture through said deck plate body, said deck plate aperture sized and configured to allow said support pole to pass therethrough;
an umbrella attachment means at or near said first end of said support pole for attaching said umbrella to said first end of said support pole, said umbrella attachment means configured to allow said umbrella to generally hang from said first end of said support pole; and
a basket plate engagement means at or near said second end of said support pole for engaging said support pole with at least one of said basket plate and said skimmer basket so as to support said support pole above the deck with said umbrella over the water surface.

14. The umbrella support system of claim 13, wherein said umbrella attachment means comprises a ball and a seat device configured to retain at least a portion of said ball.

15. The umbrella support system of claim 13, wherein said umbrella attachment means comprises a connecting member attached to said umbrella and a support member interconnecting said connecting member and said support pole.

16. The umbrella support system of claim 13, wherein said basket plate engagement means comprises a tube insert member and a connector received through a basket plate aperture in said basket plate to attach said tube insert member to a top surface of said basket plate, said tube insert member sized and configured to be received in said second end of said support pole so as to engage said second end of said support pole with said basket plate.

17. The umbrella support system of claim 13, wherein basket plate engagement means comprises a bracket on said top surface of said basket plate, said bracket having an upwardly disposed pole receiving section sized and configured to receive said second end of said support pole and a connector, said connector configured to connect said second end of said support pole to said bracket so as to engage said second end of said support pole with said basket plate.

18. The umbrella support system of claim 13, wherein basket plate engagement means comprises a basket plate aperture in said basket plate, said basket plate aperture sized and configured to allow said second end of said support pole to pass therethrough.

19. The umbrella support system of claim 18 further comprising a tube insert member at a bottom wall of said basket, said tube insert member sized and configured to be received in said second end of said support pole.

20. The umbrella support system of claim 13 further comprising an attachment apparatus configured attach to and hang below said umbrella, said attachment apparatus supported below said umbrella by an attachment pole, said attachment pole connected to an attachment connector at said umbrella.
